(19) United States
(12) Patent Application Publication
(10) Pub. No.: US 2019/0224924 A1
(43) Pub. Date: Jul. 25, 2019

(54) Micro-Pull To Strengthen Plastics Weld

(71) Applicant: Branson Ultrasonics Corporation, Danbury, CT (US)

(72) Inventor: Scott CALDWELL, New Milford, CT (US)

(73) Assignee: Branson Ultrasonics Corporation, Danbury, CT (US)

(21) Appl. No.: 16/251,324

(22) Filed: Jan. 18, 2019

Related U.S. Application Data
(60) Provisional application No. 62/620,198, filed on Jan. 22, 2018.

(51) Int. Cl. B29C 65/00; B29C 65/08; B29C 65/16

(52) U.S. Cl. CPC B29C 66/344; B29C 65/08; B29K 2025/06; B29C 65/16; B29C 66/73921

(57) ABSTRACT

Thermoplastic welding systems to weld work pieces together are provided. The work pieces are welded together at respective thermoplastic weld interface portions of the work pieces to form a weld. Before the weld interface portions have cooled, the weld interface portions are micro-pulled away from each other a micro-distance to strengthen the weld.

### CROSS-REFERENCE TO RELATED APPLICATIONS

This application claims the benefit of U.S. Provisional Application No. 62/620,198 filed on Jan. 22, 2018. The entire disclosure of the above application is incorporated herein by reference.

### FIELD

The present disclosure relates to a micro-pull to strengthen plastics weld at the interface of the weld.

### BACKGROUND

This section provides background information related to the present disclosure which is not necessarily prior art.

A broadly used process to join thermoplastic parts is plastic welding where the plastic parts are welded together at a weld interface. In this regard, the portions of the plastic parts that are welded together are referred to herein as the weld interface portions. It should be understood that the plastic parts could be made entirely of thermoplastic or could be made of a combination of thermoplastic with another material or materials.

Plastic welding involves external heating where the weld interface portions of the plastic parts are heated before being brought together (e.g., convection heating) or internal heating where the weld interface portions of the plastic parts are brought together and heated at the weld interface (e.g., converting mechanical energy into heat). In many aspects, a compressive force is applied to the plastic parts to press the weld interface portions together at a force to weld the weld interface portions together at the weld interface. Plastics welders using external heating to weld the plastic parts include hot plate welders, hot gas welders, extrusion welders, implant induction welders, and implant resistance welders. Plastics welders using internal heating to weld the plastic parts include mechanical welders, ultrasonic welders, vibration welders, spin welders, electromagnetic welders, radio frequency welders, infrared and laser welders, and microwave welders. In all such plastic welders, the weld interface portions of the plastic parts are heated, which defines a heat effected zone at the weld interface. (And, as noted above, in the majority of such plastic welders, a compressive force is applied to press the weld interface portions together at the weld interface.) Due to this heating, the plastic material at the weld interface after welding is less strong than the portions of the plastic parts not subjected to the heating.

Several factors dictate the quality of the resulting weld at the weld interface and explain why the heat effected zone is less strong. First, the heating of the polymer chains of the plastics at the heat effected zone in many circumstances shorten those polymer chains, which thereby weakens the polymer. Further, the heating and pressing of the polymer rearranges the organizational structure of the underlying polymer chains such that they lie flat relative to the weld interface surface and are oriented parallel to the weld interface surface. The polymer chains are stronger along their length, whereas cross links between various polymer chains are less strong. If the polymer chains are not randomly oriented but are parallel to the weld interface surface, the polymer is then weaker in a direction perpendicular to the weld interface compared to parallel to the weld interface surface.

### SUMMARY

This section provides a general summary of the disclosure, and is not a comprehensive disclosure of its full scope or all of its features.

According to an aspect, a method for increasing the strength of a weld joining thermoplastic weld interface portions of work pieces is provided. The method includes heating the weld interface portions of the work pieces to melt the weld interface portions. The work pieces are brought together so that their weld interface portions are against each other. Before the weld interface portions are cooled, the weld interface portions are micro-pulled away from each other a micro-distance to increase the strength of the weld.

In an aspect, bringing the work pieces together includes bringing them together to press the weld interface portions against each other with a compressive force.

According to an aspect, welding the weld interface portions includes ultrasonic welding the weld interface portions. According to an aspect, welding the weld interface portions includes laser welding the weld interface portions. According to an aspect, welding the weld interface portions includes hot plate welding the interfaces.

According to an aspect, micro-pulling the work pieces away from each other includes micro-pulling the weld interface portions away from each other a distance in the range of 0.1 thousandths of an inch to 1 thousandths of an inch.

According to an aspect, micro-pulling the weld interface portions of the work pieces away from each other includes micro-pulling weld interface portions that are amorphous polymer parent materials away from each other. According to an aspect, micro-pulling the weld interface portions of the work pieces away from each other includes micro-pulling the weld interface portions of amorphous polymer parent materials away from each other to re-orient polymer chains in the amorphous polymer parent materials to be more randomly oriented in relation to each other and more intertwined with each other.

According to an aspect, pulling the weld interface portions of the work pieces away from each other includes micro-pulling weld interface portions that are semi-crystalline polymer parent materials away from each other. According to an aspect, micro-pulling the weld interface portions of the work pieces away from each other includes micro-pulling the weld interface portions of semi-crystalline polymer parent materials away from each other to re-orient crystal domains in the semi-crystalline polymer parent materials to be less parallel in relation to each other.

According to another aspect, a thermoplastic welder for welding together work pieces to increase strength at a weld interface where thermoplastic weld interface portions of the work pieces are welded together. The thermoplastic welder includes an actuator configured to bring a plurality of weld interface portions together. The thermoplastic welder further includes a heat source to heat the weld interface portions to melt the weld interface portions. The thermoplastic welder further includes an actuator configured to micro-pull the weld interface portions away from each other a micro-distance after the heat source melts the weld interface portions but before the weld interface portions have cooled.

According to an aspect, the actuator for bringing a plurality of weld interface portions together and the actuator configured to micro-pull the weld interface portions away from each other a micro-distance are the same actuator.

According to an aspect, the actuator bringing a plurality of weld interface portions together is configured to bring the plurality of weld interface portions together to press the weld interface portions against each other with a compressive force.

According to an aspect, the thermoplastic welder is an ultrasonic welder.

According to an aspect, the thermoplastic welder is a laser welder.

According to an aspect, the thermoplastic welder is a hot plate welder.

According to an aspect, the thermoplastic welder is a vibration welder.

According to an aspect, the thermoplastic welder is a spin welder.

According to an aspect, the thermoplastic welder is an infrared welder.

According to an aspect, the thermoplastic welder is a microwave welder.

According to an aspect, the thermoplastic welder is a hot gas welder.

According to an aspect, the actuator configured to micro-pull the weld interface portions away from each other a micro-distance is configured to micro-pull the welder interface portions away from each other a distance in the range of 0.1 thousandths of an inch to 1 thousandths of an inch.

According to an aspect, the plurality of weld interface portions comprise amorphous polymers.

According to an aspect, the plurality of weld interface portions comprise semi-crystalline polymers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic representation of an amorphous polymer parent material showing random orientation of polymer chains;

FIG. 2 is a diagrammatic representation of the amorphous polymer of FIG. 1 after melting under compressive force showing polymer chains substantially perpendicular to the compressive force applied;

FIG. 3 is a diagrammatic representation of a semi-crystalline polymer parent material showing random orientation of polymer crystals;

FIG. 4 is a diagrammatic representation of the semi-crystalline polymer of FIG. 3 after melting under compressive force showing polymer chains and crystal domains substantially perpendicular to the compressive force applied;

FIG. 5 is a diagrammatic representation of a laser welding system configured to operate according to an aspect of the present disclosure;

FIG. 6 is a diagrammatic representation of weld interface portions of work pieces that are amorphous polymers after melting under compressive force and subsequent to micro-pulling before cooling according to an aspect to the present disclosure; and

FIG. 7 is a diagrammatic representation of the weld interface portions of work pieces that are semi-crystalline polymers after melting under compressive force and subsequent to micro-pulling before cooling according to an aspect of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As noted above, welding thermoplastics involves heating and in most applications, application of a compressive force to the thermoplastic weld interface portions being welded together. Suitable plastic welding processes according to the disclosure herein include those where compressive force is applied, including laser welding, hotplate welding, vibration welding, spin welding, hot gas welding, infrared welding, microwave welding and ultrasonic welding.

As is known, thermoplastics at normal temperatures are rigid and solid but at elevated temperatures soften and melt. Thermoplastics are further divided into thermoplastics comprised of amorphous polymers and thermoplastics comprised of semi-crystalline polymers.

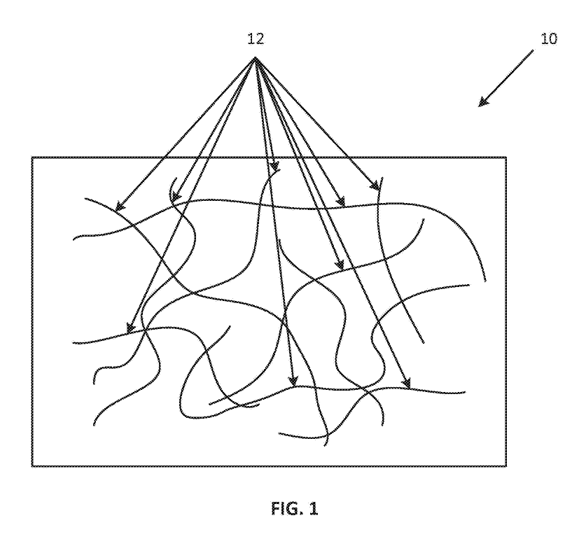

Referring first to FIG. 1, a thermoplastic that is an amorphous polymer 10 is represented diagrammatically. As can be seen, the amorphous polymer 10 has polymer chains 12 randomly distributed and intertwined with one another. Given this random distribution and arrangement, amorphous polymer thermoplastics have melting points and strains at break at least in part dictated by the actual molecular structure. This feature is believed to explain the broader range of melting points for thermoplastics that are amorphous polymers.

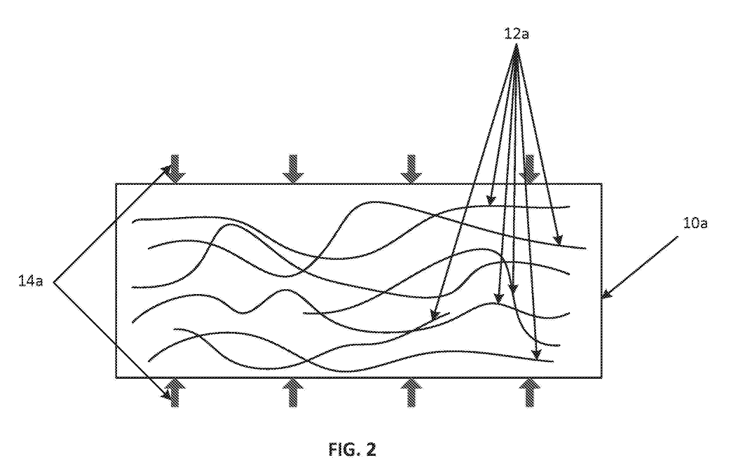

Referring to FIG. 2, a diagrammatic view of the amorphous polymer diagrammatically represented in FIG. 1 that has been melted under compressive force applied directionally as shown by arrows 14a is shown. Notably, the amorphous polymer 10a of FIG. 2 has been exposed to heat and compressive forces sufficient to weld such a thermoplastic with another thermoplastic. As can be seen, polymer chains 12a are substantially less intertwined and substantially more perpendicular to the direction in which the compressive force was applied.

According to an aspect of the present disclosure, a plurality of work pieces each having an amorphous polymer weld interface portion are welded together. In this regard, as described above, a work piece may be made entirely of the amorphous polymer and the weld interface portion is then a portion of the work piece that is welded to the weld interface portion of the other work piece. A work piece may also be of a combination of an amorphous polymer with another material or materials and the weld interface portion of the piece is then a portion of the work piece made of the amorphous polymer. Suitable amorphous polymers include ABS, ABS/polycarbonate alloy, acrylic, butadiene-styrene, phyenylene-oxide based resins, polycarbonate (a), polyetherimide, polyethersulfone (a), polystyrene, polysulfone, PVC, SAN-NAS-ASA, and PBT/polycarbonate alloy polymers. As is known, the parent materials for each of the plurality of work pieces should have sufficiently common softening temperatures (e.g., sufficiently common glass transition temperatures, T_{g}) such that welding is possible for a given application (for example, having each of the work pieces comprising ABS polymers). As known in the art, the term “parent material” refers to the material being welded. Further, it should be noted that the compatibility between the parent materials may depend upon the welding process used. As a non-limiting example, a parent material comprised of ABS polymer may not ultrasonically weld well with a different parent material, but ABS polymer may laser weld well to that same different parent material.

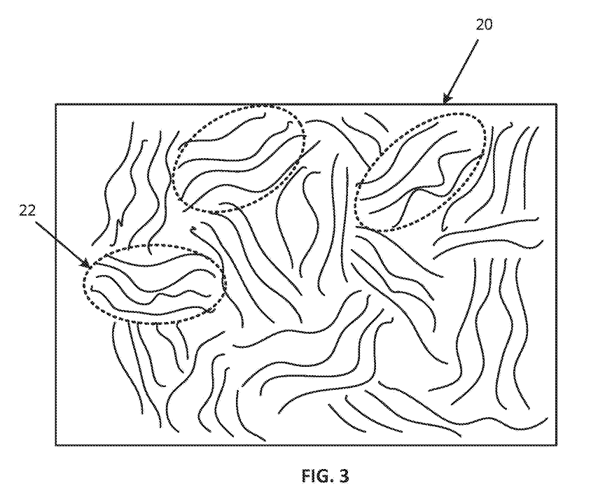

As noted above, a second group of thermoplastics are semi-crystalline polymers. Referring to FIG. 3, a semi-crystalline polymer 20 is represented diagrammatically. As can be seen, the semi-crystalline polymer 20 has a highly ordered molecular structure having several crystal domains, wherein each crystal domain 22 has several polymer chains oriented parallel to one another, rather than the random distribution and arrangement of polymer chains in amorphous polymer thermoplastics. (For clarity, only some of the crystal domains in FIG. 3 are identified with the dashed ovals 22.) Prior to application of heat and compressive forces, while the polymer chains in a single crystal domain are generally parallel, the crystal domains are not parallel to one another. Because of their highly ordered nature, semi-crystalline polymers have a much more defined, and narrow, melting point range as opposed to amorphous polymers.

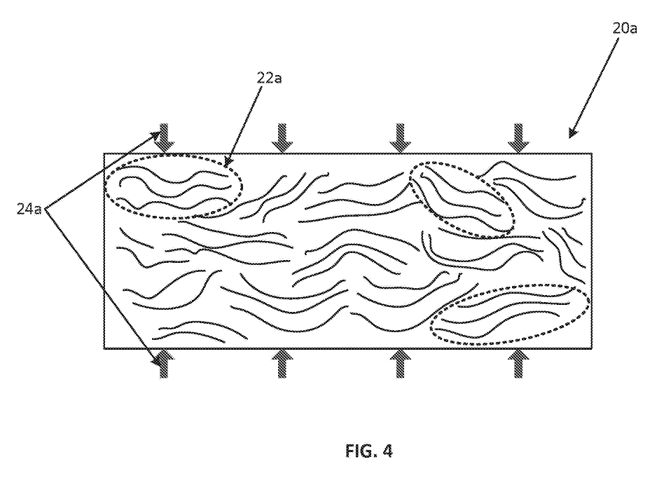

Referring to FIG. 4, a diagrammatic view of the semi-crystalline polymer diagrammatically represented in FIG. 3 that has been melted under compressive force applied directionally as shown by 24a is shown. In FIG. 4, the semi-crystalline polymer 20a of FIG. 4 has been exposed to heat and compressive forces sufficient to weld such a thermoplastic with another thermoplastic. As can be seen, crystal domains 22a are more parallel with one another after application of the heat and compressive forces, as opposed to the crystal domains 22 of the semi-crystalline polymer 20a shown in in FIG. 3. (For clarity, only some of the crystal domains in FIG. 4 are identified by the dashed ovals 22a.)

According to an aspect of the present disclosure, a plurality of work pieces each having a semi-crystalline polymer weld interface portion are welded together. In this regard, a work piece may be made entirely of the semi-crystalline polymer and the weld interface portion is then a portion of the work piece welded to the weld interface portion of the other work piece. A work piece may also be of a combination of a semi-crystalline polymer with another material or materials and the weld interface portion of the work piece is then a portion of the work piece made of the semi-crystalline polymer. Suitable semi-crystalline polymers include acetal, cellulosics, fluoropolymers, liquid crystal polymers (c), nylon (a), thermoplastic polyester, polyethylene terephthalate/PET, polybutylene terephthalate/PBT, polyetheretherketone, polyethylene, polymethylpentene, polyphenylene sulfide, and polypropylene polymers. As is known, the parent materials for each of the plurality of work pieces should have sufficiently common melting points (e.g., sufficiently common melting temperatures, Tₘ) such that welding is possible for a given application (for example, having each of the work pieces comprising acetal polymers). As a non-limiting example, a parent material comprised of acetal polymer may not ultrasonically weld well with a different parent material, but acetal polymer may laser weld well to that same parent material.

According to yet another embodiment, it is envisioned that under some instances, a work piece having a semi-crystalline polymer weld interface may be welded together with a work piece having an amorphous polymer weld interface.

In welding the weld interface portions of the work pieces together, the weld interface portions are heated to melt them. The work pieces are brought together, before, during or after melting depending on the type of welding process being used. A compressive force is also typically applied to the work pieces, during or after they are melted again depending on the type of welding process being used, to press the weld interface portions of the work pieces together at a weld interface. After an active weld cycle and before cooling of the weld interface portions, the weld interface portions are micro-pulled away from each other by pulling them away from each other by a micro-distance. Illustratively, the work pieces are micro-pulled away from each other to micro-pull the weld interface portions away from each other. After the weld interface portions have been pulled away from each other the micro-distance, the weld interface portions are allowed to cool.

As used herein, a micro-distance is a distance sufficient to re-orient the polymer chains in an amorphous polymer so that they are more randomly oriented with respect to each other and to re-orient the crystal domains of semi-crystalline polymer to increase the strength of the weld compared to weld interface portions not being pulled away from each other by the micro-distance.

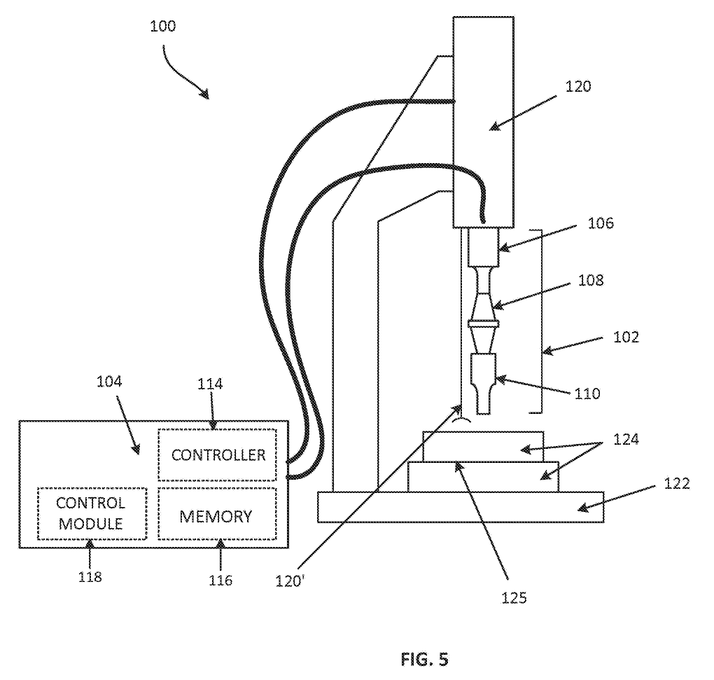

As noted above, the embodiments referenced herein include welding a plurality of thermoplastic work pieces, such as a plurality of amorphous polymers, a plurality of semi-crystalline polymers, and/or at least an amorphous polymer to at least a semi-crystalline polymer. Referring to FIG. 5, an example of a plastic welding system that welds the work pieces together as described above is presented. In the example of FIG. 5, the plastic welding system is an ultrasonic plastic welding system 100. Ultrasonic plastic welding system 100 includes an ultrasonic stack 102 and ultrasonic power supply 104. Typical components of ultrasonic stack 102 include an ultrasonic converter 106, a booster 108 and an ultrasonic horn 110. It should be appreciated that not every ultrasonic stack 102 includes booster 108. Ultrasonic horn 110 will often have one or more ultrasonic horn tips (not shown). Booster 108 and ultrasonic horn 110 are ultrasonically connected (directly or via another component) to ultrasonic converter 106. An actuator 120 moves ultrasonic stack 102 and/or anvil 122 relative to the two work pieces 124 so as to deliver ultrasonic weld energy to weld interface portions 125 of the work pieces 124. In this manner, ultrasonic stack 102 is a heat source 102 that heats weld interface portions 125 by the application of ultrasonic energy to weld interface portions 125, causing weld interface portions 125 of the two work pieces 124 melt and bond with one another, thereby forming a weld.

Actuator 120 is configured to pull the weld interface portions 125 away from each other a micro-distance after an active weld cycle but before the weld interface portions 125 of the two work pieces 124 have cooled. An active weld cycle as used herein is when heat and/or compressive force is being applied to the work pieces. In an aspect, actuator 120 pulls the two work pieces 124 away from each other to pull the weld interface portions 125 away from each other. More specifically, actuator 120 is configured to pull the two work pieces 124 away from each other a distance in the range of 1 thousandths of an inch to 0.1 thousandths of an inch.

According to another embodiment, an actuator 120′, separate from actuator 120, includes at least a pulling member (such as a suction cup, gripper, magnet, an adhesive member, and the like). Each pulling member is configured to pull the two work pieces 124 away from one another the micro-distance after the active weld cycle and before the weld interface portions 125 of the two work pieces 124 have cooled. In an aspect, the micro-distance is in the range of 1 thousandths of an inch to 0.1 thousandths of an inch.

Either or both of actuator 120 and actuator 120′ can comprise an actuation system, including actuators used in servo systems, pneumatic systems, magnetic systems, hydraulic systems, mechanical systems, and the like. A preferred actuator system is a servo system due to its ability to precisely control the position of the actuator.

Either or both of actuator 120 and actuator 120′ can be controlled by ultrasonic power supply 104, which is controlled by a controller 114 that includes memory 116. Controller 114 can further include control module 118, which may be implemented in control logic in controller 114, such as in software or firmware (though these controls can also be embedded in mechanical hardware, electrical digital hardware, electrical analog hardware, software, firmware, or any combination thereof). When it is stated that controller 114 has logic for a function, it should be understood that such logic can include hardware, software, or a combination thereof.

Further, while the aforementioned discussion has revolved around ultrasonic plastic welding system 100, it should be understood that the foregoing method of pulling thermoplastic weld interface portions apart a micro-distance after an active cycle and before the weld interface portions have cooled can by utilized in other types of plastic welding systems. Non-limiting examples of such plastic welding systems include ultrasonic, vibration, hot plate, hot gas, infrared, spin, microwave, and laser welding systems. It should be further noted that as is known, such plastic welding systems include different components (as an example, a laser welding system uses as a heat source a laser rather than an ultrasonic stack).

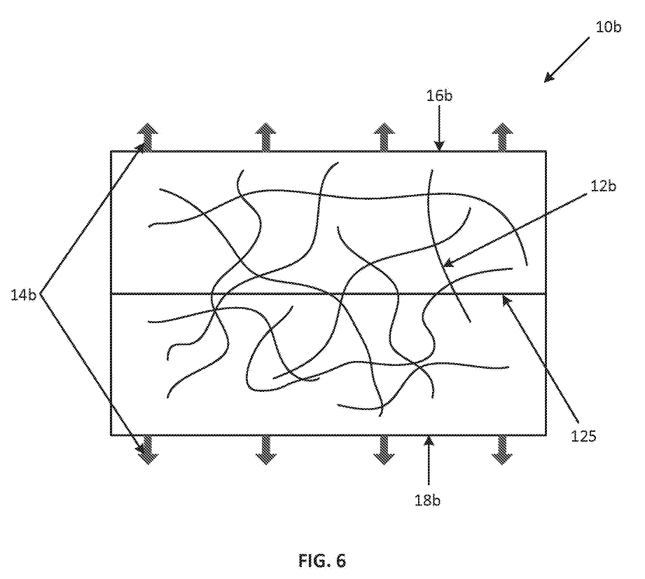

Referring to FIG. 6, a diagrammatic view of the weld interface portions 10b of a plurality 16b, 18b of work pieces (e.g., weld interface portions 125 of work pieces 124) of amorphous polymers having been micro-pulled away from each other (directionally shown by arrows 14b) by an actuator (such as actuator 120 or actuator 120′) after an active welding cycle and prior to cooling is presented. Notably, FIG. 6 demonstrates that the polymer chains 12b have become somewhat randomized and intertwined. Providing such an orientation increases the strength of the weld interface and prevents shear deformation.

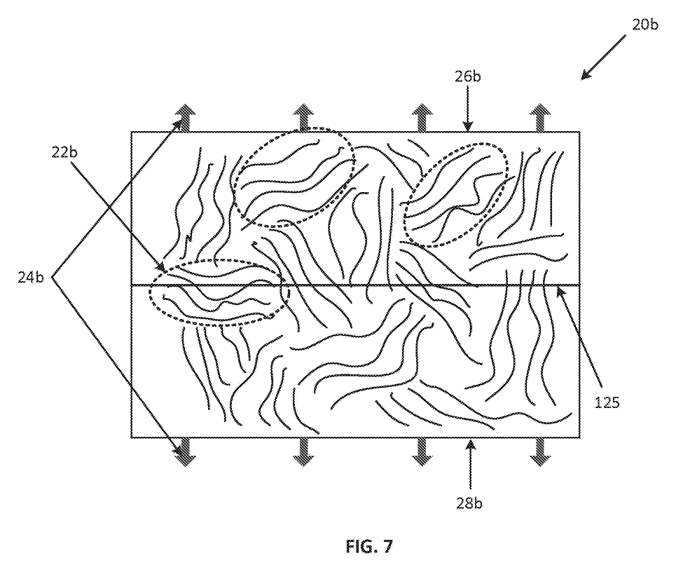

Referring to FIG. 7, a diagrammatic view of the weld interface portions 20b of a plurality 26b, 28b of work pieces (e.g., weld interface portions 125 of work pieces 124) of semi-crystalline polymers having been micro-pulled away from each other (directionally shown by arrows 24b) by an actuator (such as actuator 120 or actuator 120′) after an active weld cycle and prior to cooling is presented. Notably, FIG. 7 demonstrates that the crystal domains 22b have become less parallel in relation to one another. Providing such an orientation increases the strength of the weld interface and prevents shear deformation. (For clarity, only some of the crystal domains in FIG. 7 are identified by the dashed ovals 22b.)

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As used herein, the term controller, control module, control system, or the like may refer to, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. When it is stated that such a device performs a function, it should be understood that the device is configured to perform the function by appropriate logic, such as software, hardware, or a combination thereof.

What is claimed is:

1. A method of welding together work pieces to increase strength of a weld at a weld interface where thermoplastic weld interface portions of the work pieces are welded together, the method comprising:
heating the weld interface portions of the work pieces to melt the weld interface portions;
bringing the work pieces together so that their weld interface portions are against each other; and
before the weld interface portions have cooled, micro-pulling the weld interface portions away from each other a micro-distance to increase the strength of the weld.

2. The method of claim 1 wherein bringing the work pieces together includes bringing them together to press the weld interface portions against each other with a compressive force.

3. The method according to claim 2, wherein welding the weld interface portions includes ultrasonic welding the weld interface portions.

4. The method according to claim 2, wherein welding the weld interface portions includes laser welding the weld interface portions.

5. The method according to claim 2, wherein welding the weld interface portions includes hot plate welding the weld interface portions.

6. The method according to claim 2, wherein welding the weld interface portions includes vibration welding the weld interface portions.

7. The method according to claim 2, wherein welding the weld interface portions includes spin welding the weld interface portions.

8. The method according to claim 2, wherein welding the weld interface portions includes infrared welding the weld interface portions.

9. The method according to claim 2, wherein welding the weld interface portions includes hot gas welding the weld interface portions.

10. The method according to claim 2, wherein welding the weld interface portions includes microwave welding the weld interface portions.

11. The method according to claim 2, wherein micro-pulling the weld interface portions away includes micro-pulling the weld interface portions away from each other a distance in the range of 0.1 thousandths of an inch to 1 thousandths of an inch.

12. The method according to claim 2, wherein micro-pulling the weld interface portions of the work pieces away from each other includes micro-pulling weld interface portions that are amorphous polymer parent materials away from each other.

13. The method of claim 12, wherein micro-pulling the weld interface portions of the work pieces away from each other includes micro-pulling the weld interface portions of amorphous polymer parent materials away from each other to re-orient polymer chains in the amorphous polymer parent materials to be more randomly oriented in relation to each other and more intertwined with each other.

14. The method according to claim 2, wherein pulling the weld interface portions of the work pieces away from each other includes micro-pulling weld interface portions that are semi-crystalline polymer parent materials away from each other.

15. The method according to claim 2 wherein micro-pulling the weld interface portions of the work pieces away from each other includes micro-pulling the weld interface portions of semi-crystalline polymer parent materials away from each other to re-orient crystal domains in the semi-crystalline polymer parent materials to be less parallel in relation to each other.

16. A thermoplastic welder for welding together work pieces to increase strength at a weld interface where thermoplastic weld interface portions of the work pieces are welded together, the thermoplastic welder comprising:
an actuator configured to bring a plurality of weld interface portions together;
a heat source configured to heat the weld interface portions to melt the weld interface portions;
an actuator configured to micro-pull the weld interface portions away from each other a micro-distance after the heat source melts the weld interface portions but before the weld interface portions have cooled.

17. The thermoplastic welder of claim 16, wherein the actuator for bringing a plurality of weld interface portions together and the actuator configured to micro-pull the weld interface portions away from each other a micro-distance are the same actuator.

18. The thermoplastic welder of claim 16, wherein the actuator for bringing a plurality of weld interface portions together is configured to bring the plurality of weld interface portions together to press the weld interface portions against each other with a compressive force.

19. The thermoplastic welder of claim 16, wherein the thermoplastic welder is an ultrasonic welder.

20. The thermoplastic welder of claim 16, wherein the thermoplastic welder is a laser welder.

21. The thermoplastic welder of claim 16, wherein the thermoplastic welder is a hot plate welder.

22. The thermoplastic welder of claim 16, wherein the thermoplastic welder is a vibration welder.

23. The thermoplastic welder of claim 16, wherein the thermoplastic welder is a spin welder.

24. The thermoplastic welder of claim 16, wherein the thermoplastic welder is a infrared welder.

25. The thermoplastic welder of claim 16, wherein the thermoplastic welder is a hot gas welder.

26. The thermoplastic welder of claim 16, wherein the thermoplastic welder is a microwave welder.

27. The thermoplastic welder of claim 16, wherein the actuator configured to micro-pull the weld interface portions away from each other a micro-distance is configured to micro-pull the welder interface portions away from each other a distance in the range of 0.1 thousandths of an inch to 1 thousandths of an inch.

28. The thermoplastic welder of claim 16, wherein the plurality of weld interface portions comprise amorphous polymers.

29. The thermoplastic welder of claim 16, wherein the plurality of weld interface portions comprise semi-crystalline polymers.
